(19) United States
(12) Patent Application Publication
(10) Pub. No.: US 2009/0044006 A1
(43) Pub. Date: Feb. 12, 2009

(54) SYSTEM FOR BLOCKING SPAM MAIL AND METHOD OF THE SAME

(76) Inventors: Dongho Shim, Seoul (KR); Yunchan Kim, Seoul (KR)

Correspondence Address: PEPPER HAMILTON LLP, ONE MELLON CENTER, 50TH FLOOR, 500 GRANT STREET, PITTSBURGH, PA, 15219, US

(21) Appl. No.: 11/568,815

(22) PCT Filed: May 30, 2006
(86) PCT No.: PCT/KR06/02089

§ 371 Date: Feb. 8, 2007

(30) Foreign Application Priority Data
May 31, 2005 (KR) 10-2005-0046446
May 31, 2005 (KR) 10-2005-0046472

(51) Int. Cl. H04L 9/32; G06F 15/16; H04L 9/00

(52) U.S. Cl. 713/151; 726/6; 709/206; 713/176

(57) ABSTRACT

The present invention generally relates to a system for blocking spam mail and a method of the same, and the system in accordance with the present invention, comprising: a Mail transceiver receiving the e-mail, temporarily storing the e-mail in a temporary storage for a set time after authentication mail is transmitted, and deleting the e-mail it a sender's response is not received within the set time, then transmitting the temporarily stored e-mail to mail accounts of recipients of a mail server if the sender's response is received within the set time; an authenticator list classifying and storing, according to each recipient, an e-mail address of the sender authenticated through the authentication mail and an e-mail address of a random sender registered by the recipients of the e-mail to receive the e-mail without authentication; and an authentication processor retrieving whether the e-mail address of the sender is included in the authenticator list, sending the authentication mail to the e-mail address of the sender if the e-mail address of the sender is not included in the authenticator list, and authenticating the sender according to the sender's access and response for the authentication mail.

### TECHNICAL FIELD

The present invention generally relates to a system for blocking spam mail and a method of the same, and more specifically, to a system for blocking spam mail and a method of the same to block reception of spam mail which is randomly transmitted in large quantities for the purpose of advertising, among e-mail sent through the Internet or a wireline & wireless communication network.

### BACKGROUND ART

E-mail is a communication means for transmitting messages in multilateral way through the Internet or a wireline & wireless communication network, and the usage of the e-mail is increasing at fast speed. Likewise, as the e-mail is generally used and the importance of the e-mail gets larger, spam mail which uses the e-mail as the medium of advertising/marketing for many and unspecified persons is dramatically increasing as well. Thus, it takes a lot of time and effort for the recipient to check and delete unnecessary spam mail, and furthermore, the recipient may be exposed to malicious codes and may unnecessarily waste the resources of the network and a system.

The prior art for blocking the spam mail representatively presents a method for retrieving whether particular words are included in the title or the contents of the text of e-mail based on common characteristics of the spam mail to filter the retrieved words, and particularly, a method for writing a blacklist for e-mail addresses or domains reported as spam mail to block e-mail transmitted from the domains or the e-mail addresses.

However, in case of the method for retrieving and filtering the particular words, it is hard to effectively block spam mail which is advancing day by day since it is based on certain information inferred from the spam mail received in the past, and also if spam mail is composed of images instead of text, an appropriate filtering process is not possible. In addition, because e-mail containing particular words is filtered, even normal e-mail which includes the particular words can be filtered as well. And, in case of the method for using the blacklist, if the sender of spam mail uses various sender e-mail addresses or generates a virtual e-mail address, there is no way to block such spam mail.

Accordingly, technology for effectively blocking randomly transmitted spam mail is essential.

### DISCLOSURE OF INVENTION

### Technical Problem

It is therefore an object of the present invention to provide a system for blocking spam mail and a method of the same to authenticate a sender of e-mail with a predetermined authentication mail and to make recipients receive the e-mail, which is sent from the authenticated sender only, as normal e-mail, thereby efficiently blocking spam mail randomly transmitted to unspecified recipients.

Also, it is another object of the present invention to provide a system for blocking spam mail and a method of the same to make a mail system receive mail by distinguishing authentication mail from general e-mail (spam mail, general mail) when the authentication mail is transmitted to a sender of e-mail, thereby preventing the authentication mail only from being indefinitely transceived between mail systems of the sender and recipients.

Moreover, it is another object of the present invention to provide a system for blocking spam mail and a method of the same to enable recipients to randomly receive and check e-mail transmitted from a sender, before a response for authentication mail sent to authenticate the sender of the e-mail is received.

Besides, it is another object of the present invention to provide a system for blocking spam mail and a method of the same to use a 2-step transmission method for authenticating a sender by primarily sending some of authentication mail and transmitting the rest of the authentication mail without sending the authentication mail as much as an amount of e-mail sent by the sender of the received e-mail, in order to prevent damage caused when a lot of authentication mail is transmitted at a time to an e-mail address when a spammer transmits spam mail by using the corresponding e-mail address of other person.

Technical Solution In order to accomplish the above object, a system for blocking spam mail in accordance with the present invention is a spam mail blocking system located on a front end of a mail server which transceives e-mail, transmitting authentication mail for authenticating a sender to an e-mail address of the sender who sends e-mail, authenticating the sender depending on whether the sender responds to the authentication mail, and processing reception/deletion of the e-mail, comprising: a mail transceiver receiving the e-mail, temporarily storing the e-mail in a temporary storage for a set time after the authentication mail is transmitted, deleting the e-mail if the sender's response is not received within the set time, and transmitting the temporarily stored e-mail to mail accounts of recipients of the mail server if the sender's response is received within the set time; an authenticator list classifying and storing, according to each recipient, the e-mail address of the sender authenticated through the authentication mail and an e-mail address of a random sender registered by the recipients of the e-mail to receive the e-mail without authentication; and an authentication processor retrieving whether the e-mail address of the sender is included in the authenticator list, sending the authentication mail to the e-mail address of the sender if the e-mail address of the sender is not included in the authenticator list, and authenticating the sender according to the sender's access and response for the authentication mail.

Desirably, the authentication mail includes predetermined identification information for distinguishing the authentication mail from general e-mail, in a header of the authentication mail. Besides, the system for blocking the spam mail performs a protocol for distinguishing the authentication mail from the general e-mail with the mail server in which the sender is registered, on a front end of a protocol for sender/recipient mail account confirmation among mail transfer protocols. The mail transceiver provides a pending list which is linked with the temporarily stored e-mail so that the recipients select the e-mail temporarily stored in the temporary storage to receive and store the selected e-mail. At this time, the mail transceiver transmits the e-mail selected by the recipients from the pending list to the mail accounts of the recipients of the mail server, irrespective of the response for the authentication mail, and the authentication processor adds the e-mail address of the sender for the e-mail selected by the recipients from the pending list, to the authenticator list. More desirably, the authentication mail includes access information, which contains a URL for the sender to access the authentication processor, and a unique key for authenticating the sender, and the authentication processor stores the unique key for the authentication mail and an equivalent key value for verifying the sender's response for the unique key, then authenticates the sender by confirming the sender's access through the authentication mail and comparing the sender's response for the unique key with the key value. Furthermore, it is available that the authentication mail includes the access information which contains the URL for the sender to access the authentication processor, and the authentication processor displays special character patterns processed in graphics on a web page linked with the access information and authenticates the sender by inputting the special character patterns from the sender, or it is possible that the authentication mail includes the access information which contains the URL for the sender to access the authentication processor, and the authentication processor provides a question with an answer on the web page linked with the access information, and inputs an answer from the sender to authenticate the sender depending on whether the answer of the sender is correct. In addition, the system for blocking the spam mail, further comprising: a blacklist storing an e-mail address or an IP address of a sender, wherein all of the recipients registered in the mail server refuse to receive the e-mail transmitted from the sender; a blacklist processor liking with the temporary storage, the pending list, and the authenticator list, and registering the e-mail address or the IP address of the sender of e-mail having the same characteristics by comparing each characteristic of each of the e-mail, which all of the recipients of the e-mail do not receive through the pending list, among the e-mail temporarily stored in the temporary storage during the set time, then comparing the blacklist with the authenticator list in real time to delete the e-mail address of the sender, which is commonly included in the blacklist and the authenticator list, from the blacklist; and a blacklist blocker located on a front end of the mail transceiver, and blocking the reception of the e-mail transmitted from the e-mail address or IP address included in the blacklist among the received e-mail. On this occasion, the characteristics compared by the blacklist processor include the e-mail address of the sender, a sending IP, a title of the e-mail, and the contents of the text of the e-mail.

As well, in order to achieve another object of the present invention, a method of blocking spam mail is a spam mail blocking method for transmitting authentication mail for authenticating a sender to an e-mail address of the sender who sends e-mail, on a front end of a mail server A which transceives the e-mail, authenticating the sender depending on whether the sender responds to the authentication mail, and for transmitting the e-mail of the authenticated sender to recipients, comprising: a first step of receiving the e-mail; a second step of retrieving the e-mail address of the sender from an authenticator list which is a list of the e-mail address of the sender whose the e-mail is authenticated and permitted to be transmitted to the recipients; if the e-mail address of the sender exists in the authenticator list, a third step of transmitting the e-mail to mail accounts of the recipients of the mail server A; if the e-mail address of the sender does not exist in the authenticator list, a fourth step of transmitting the authentication mail to the e-mail address of the sender, and temporarily storing the e-mail in a temporary storage for a predetermined set time; if the sender's response for the authentication mail is received within the set time, a fifth step of transmitting the e-mail temporarily stored in the temporary storage to the mail accounts of the recipients of the mail server A, and adding the e-mail address of the sender to the authenticator list; and if the sender's response for the authentication mail is not received within the set time, a sixth step of deleting the e-mail temporarily stored in the temporary storage; and wherein the third step and the fourth to sixth steps are selectively carried out while the fifth step and the sixth step are selectively carried out.

Desirably, the fourth step is composed of a 4-1 step of generating predetermined identification information so that a mail server B in which the e-mail address of the sender is registered can distinguish the authentication mail from general e-mail, and a 4-2 step of inserting the identification information into the authentication mail. The fourth step includes a 4-3 step of transmitting a message which demands a transmission permission of the authentication mail to the mail server B in which the e-mail address of the sender is registered, and the 4-3 step can be performed on a front end of a protocol for sender/recipient mail account confirmation among mail transfer protocols, so as to communicate with the mail server B. In this case, after the 4-3 step, it is desirable that the method of blocking spam mail further comprises a 4-4 step of which the mail server A receives an identification code transmitted and generated according to certain rules by the mail server B in order to verify transmission of the authentication mail, a 4-5 step of transmitting response codes, which are generated by the certain rules and key values in a pair for the identification code, to the mail server B, and a 4-6 step of receiving a message that approves of transmission of the authentication mail from the mail server B. Also, the authentication mail includes access information that contains a URL for the sender to access a predetermined web page to respond to the authentication mail and a unique key for authenticating the sender. And, the fifth step consists of a 5-1 step of authenticating the sender by inputting a key value corresponding to the unique key as a response from the sender. It is possible that the authentication mail includes the access information that contains the URL for the sender to access the predetermined web page to respond to the authentication mail, and the fifth step includes a 5-2 step of displaying special character patterns processed in graphics on the web page linked with the access information and a 5-3 step of authenticating the sender by inputting the special character patterns from the sender, or it is available that the authentication mail includes the access information that contains the URL for the sender to access the predetermined web page to respond to the authentication mail, and the fifth step includes a 5-4 step of providing a question with an answer on the web page linked with the access information and a 5-5 step of inputting an answer from the sender and authenticating the sender depending on whether the answer of the sender is correct. More desirably, the method of blocking spam mail in accordance with the present invention, further comprising: a seventh step of providing a pending list which is linked with the e-mail to the recipients to check the e-mail temporarily stored in the temporary storage; an eighth step of transmitting the e-mail selected by the recipients from the pending list to the mail accounts of the recipients of the mail server A, irrespective of the response for the authentication mail; and a ninth step of adding the e-mail address of the sender to the authenticator list, for the e-mail selected by the recipients from the pending list; and wherein the eighth step and the ninth step are carried out regardless of order while the seventh to ninth steps are carried out with the fourth to sixth steps regardless of order. In addition, the method of blocking spam mail in accordance with the present invention, further comprising: a tenth step of blocking reception of e-mail transmitted from an e-mail address or an IP address included in a blacklist which stores the e-mail address or the IP address of the sender, wherein all of the recipients registered in the mail server A refuse to receive the e-mail transmitted from the sender, an eleventh step of registering, in the blacklist, the e-mail address or the IP address of the sender of e-mail having the same characteristics, by comparing each characteristic of each of the e-mail that all of the recipients of the e-mail do not select through the pending list in the eighth step and the ninth step, among the e-mail temporarily stored in the temporary storage for the set time in the fourth step, and a twelfth step of comparing the blacklist with the authenticator list in real time to delete the e-mail address of the sender commonly included in the blacklist and the authenticator list, from the blacklist; and wherein the tenth step is carried out prior to the first step, and the eleventh step is selectively carried out with the eighth step and the ninth step while the twelfth step is carried out with the first to ninth steps regardless of order. At this point, with regards to each of the e-mail which is not selected by all of the recipients of the e-mail through the pending list in the eighth step and the ninth step among the e-mail temporarily stored in the temporary storage during the set time in the fourth step, the eleventh step includes: an 11-1 step of comparing the e-mail address of the sender, and if e-mail having the same e-mail address of the sender is in plural, registering the e-mail address of the sender of the e-mail having the same e-mail address of the sender, in the blacklist, an 11-2 step of comparing a sending IP, and if e-mail having the same sending IP is in plural, registering the IP address of the sender of the e-mail having the same sending IP, in the blacklist, an 11-3 step of comparing a title of the e-mail, and if e-mail having the same title is in plural, registering the e-mail address or the IP address of the sender of the e-mail having the same title, in the black list, and an 11-4 step of hashing the contents of the text of the e-mail to convert the contents of the text into a code, and comparing the converted codes, then if e-mail having the same converted code is in plural, registering the e-mail address or the IP address of the sender of the e-mail having the same converted code, in the blacklist; and wherein the 11-1 to 11-4 steps are carried out regardless of order.

### BRIEF DESCRIPTION OF THE DRAWINGS

FIG. 1 is a format diagram of a system for blocking spam mail in accordance with the present invention;

FIG. 2 is a flow chart showing a spam mail blocking process in accordance with the present invention;

FIG. 3 is a diagram for illustrating a mail transceiving process in a general SMTP session;

FIG. 4 and FIG. 5 are diagrams for illustrating a process of transceiving authentication mail in accordance with the present invention;

FIG. 6 is a flow chart showing a process of transmitting authentication mails by dividing the authentication mails in 2 stages;

FIG. 7 is a format diagram of another embodiment of a system for blocking spam mail in accordance with the present invention; and

FIG. 8 is a flow chart showing a spam mail blocking process using a blacklist in accordance with the present invention.

### MODE FOR THE INVENTION

The present invention now will be described more fully hereinafter with reference to the accompanying drawings, in which typical embodiments of the invention are shown.

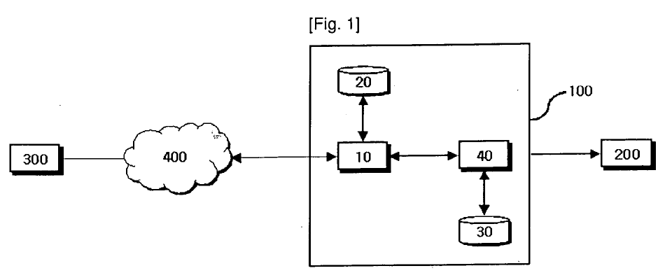

FIG. 1 is a format diagram of a system for blocking spam mail in accordance with the present invention. Like shown in FIG. 1, respective mail servers (200,300) transceive e-mail through the Internet or a wireline & wireless communication network (400), and a system (100) for blocking spam mail in accordance with the present invention is located on a front end of the mail server (200). The mail servers (200,300) are general mail servers for transceiving the e-mail, and register mail accounts of a sender and recipients for transceiving the e-mail. FIG. 1 illustrates an embodiment that the system for blocking spam mail is comprised in the mail server (200) only, and the mail server (300) refers to a mail server where the mail account of the sender of the e-mail is registered, while the mail server (200) refers to a mail server where the mail accounts of the recipients of the e-mail are registered.

The system (100) for blocking spam mail in accordance with the present invention consists of a mail transceiver (10) transceiving the e-mail with the mail server (300), a temporary storage (20) temporarily storing the received e-mail, an authenticator list (30) storing a list of the sender authenticated by the system (100) for blocking spam mail, and an authentication processor (40) authenticating the sender by generating and sending authentication mail to the sender. Meanwhile, it is also possible to transmit the authentication mail by the mail transceiver (10). The mail transceiver (10) in accordance with the present invention transceives the e-mail through the Internet or the wireline & wireless communication network (400). Therefore, the e-mail transmitted by the sender from the mail server (300) is received by the mail transceiver (10), and is stored in the temporary storage (20). The temporary storage (20) temporarily stores the e-mail until authentication is determined by the authentication processor, and classifies the e-mail according to the recipients of the e-mail to store the classified e-mail. In addition, the mail transceiver (10) transmits the corresponding e-mail to the mail server (200) according to the authentication of the authentication processor (40), or deletes the e-mail. In detail, if the authentication is complete by the authentication processor, the mail transceiver (10) extracts the corresponding e-mail from the temporary storage (20), and transmits the extracted e-mail to e-mail addresses of the corresponding recipients of the mail server (200). The e-mail transmitted to the mail server (200) is stored in special storage areas (now shown) assigned to the corresponding recipients, so that the recipients can receive and check the stored e-mail. On the contrary, if the authentication is not conducted by the authentication processor, that is, if the corresponding e-mail is decided as spam mail, the mail transceiver (10) deletes the e-mail stored in the temporary storage (20).

The authenticator list (30) in accordance with the present invention is an e-mail address list of a sender whose e-mail is approved/authenticated to be transmitted to the recipients, and is individually generated according to each recipient, that is, each mail account user of the mail server (200). E-mail addresses of senders included in the authenticator list contain e-mail addresses of senders who are completely authenticated by the authentication processor, and e-mail addresses of senders individually registered by each recipient.

The authentication processor (40) in accordance with the present invention authenticates a sender of e-mail through authentication mail, thereby blocking spam mail transmitted from a spammer. Specifically, the authentication processor (40) retrieves the sender of the received e-mail from the authenticator list (30), and generates the authentication mail to send the generated authentication mail if the sender is not included in the authenticator list (30). The authentication mail contains access information such as a URL for the sender to access the authentication processor (40). Besides, the authentication processor (40) stores a unique key for the authentication mail and a key value corresponding to the unique key together with the unique key. The corresponding key value refers to a value for verifying a response of the sender for the unique key, and the authentication processor transmits the authentication mail by including the unique key in the authentication mail, and authenticates the sender by comparing the sender's response with the corresponding key value. A detailed authentication process of the authentication processor using the unique key and the key value corresponding to the unique key can be performed in various types. For instance, the authentication processor (40) displays special character patterns processed in graphics on a web page accessed by the sender through the access information, that is, a web page linked with the access information, and requests the special character patterns to be inputted as a response. The special character patterns processed in graphics are character patterns which the sender can immediately analyze or read the meaning with the naked eye, requesting authentication in public. If the sender inputs the special character patterns as the response, the authentication processor compares the inputted patterns with the stored value to authenticate the sender. As another example of the authentication process of the authentication processor (40), the authentication processor displays a question with an answer on the web page linked with the access information, inputs an answer from the sender, and authenticates the sender according to the answer of the sender by comparing the answer of the question with the answer of the sender. At this time, the displayed question should have a level of difficulty that the sender can immediately find out the answer. Thus, a sender (spammer) who transmits spam mail in large quantities or transmits the spam mail by using a randomly generated fake account cannot receive the authentication mail or should respond to each authentication mail. As a result, the sender of the spam mail can be effectively picked out. If the authentication is complete by receiving the sender's response for the authentication mail, the authentication processor (40) adds an e-mail address of the corresponding sender to the authenticator list (30), and transmits a message indicative of authentication completion to the mail transceiver (10). In the meantime, if the response is not received from the sender within a set time, the authentication processor (40) decides the corresponding e-mail as spam mail, and transmits a message indicative of authentication failure to the mail transceiver. Accordingly, the mail transceiver (10) transmits the e-mail stored in the temporary storage (20) to the mail server (200) or deletes the e-mail, according to the authentication completion or authentication failure message of the authentication processor (40).

On the other hand, each e-mail stored in the temporary storage (20) can be provided in list type to the corresponding recipients while the authentication for the sender is not complete. Namely, mail account registers (recipients) of the mail server (200) can check a list (hereinafter, called ‘pending list’) of the e-mail which is not completely authenticated, and can selectively receive the e-mail from the list. At this moment, the mail transceiver (10) extracts the e-mail selected by the recipients from the temporary storage (20), and transmits the extracted e-mail to the corresponding recipients' mail accounts of the mail server (200). Therefore, the e-mail received to the recipients through such a procedure is not deleted irrespective of whether the sender is authenticated or not.

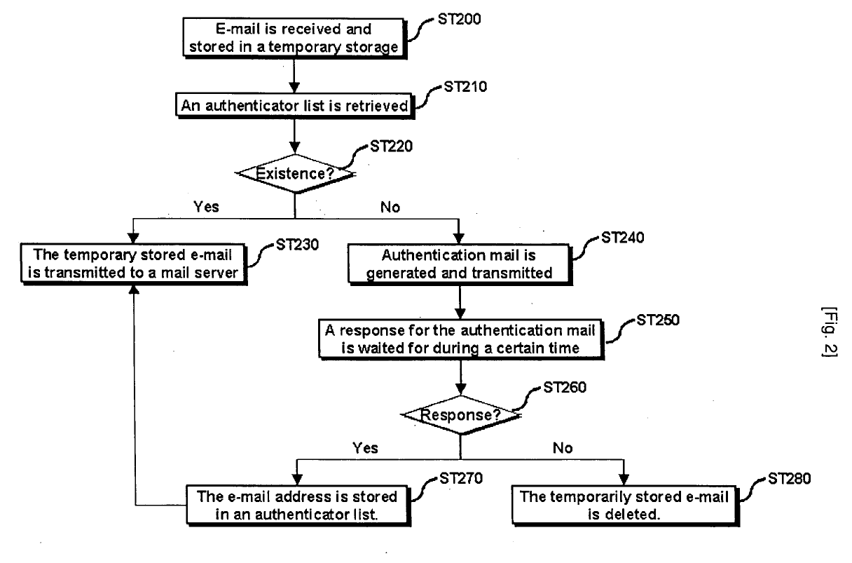

FIG. 2 is a flow chart showing a spam mail blocking process in accordance with the present invention. Referring to FIG. 2, the spam mail blocking process in accordance with the present invention will be described as follows.

When e-mail is transmitted from the mail server (300), the mail transceiver (10) receives the e-mail, and stores the received e-mail in the temporary storage (20) (ST200).

The authentication processor (40) retrieves whether a sender of the e-mail is included in the authenticator list (30) (ST210). Concretely, an e-mail address of the sender included in the e-mail is retrieved from the authenticator list (30).

If the e-mail address of the sender is included in the authenticator list (30), the mail transceiver (10) transmits the e-mail stored in the temporary storage (20) to mail accounts of recipients of the mail server (200) (ST220, ST230).

On the contrary, if the e-mail address of the sender does not exist in the authenticator list, the authentication processor (40) generates authentication mail to send the authentication mail to the e-mail address of the sender (ST220, ST240). At this time, it is desirable to generate the authentication mail by using prestored generation formats (contents of the text, access information, code, etc.). The authentication mail includes access information such as a URL for the sender to access the authentication processor (40), and a unique key for authenticating the sender.

The authentication processor (40) waits for the sender's response for the authentication mail during a preset time (ST250).

If the response is received from the sender within the set time, the authentication processor (40) compares the response with a key value corresponding to the unique key to authenticate the sender, and registers the e-mail address of the sender in the authenticator list (30) (ST260, ST270). In a concrete way, if the sender accesses a web page linked with the access information of the authentication mail and inputs special character patterns by seeing the displayed patterns which are processed in graphics or inputs an answer for a question displayed on the web page, the authentication processor confirms the inputted special character patterns or the inputted answer to authenticate the sender, and registers the e-mail address of the sender in the authenticator list. Thus, future e-mail received to the e-mail address of the sender can be immediately transmitted to the mail server (200) without authentication through authentication mail.

Also, the mail transceiver (10) transmits the e-mail temporarily stored in the temporary storage (20) to the recipients' mail accounts of the mail server (200) (ST230).

Meanwhile, if the sender does not access the authentication processor (40) within the set time, the authentication processor transmits a message indicative of authentication failure to the mail transceiver (10), and the mail transceiver deletes the e-mail stored in the temporary storage (ST260, ST280).

In addition, the authenticator list (30) can make the recipients directly access and change the e-mail address of the sender to add or delete the e-mail address, and also, it is possible for the recipients to set a ‘reception prohibited’ function for an e-mail address of a particular sender. If the recipients delete the e-mail address of the registered sender from the authenticator list, future e-mail received from the e-mail address of the corresponding sender may be received after being authenticated again via the authentication steps ‘ST240’ to ‘ST270’. And, in case of the e-mail address where the ‘reception prohibited’ function is set, it is desirable not to conduct any authentication before the recipients separately release the function. On this occasion, the mail transceiver (10) immediately deletes e-mail transmitted from the ‘reception prohibited’ e-mail address, from the temporary storage (20) without any authentication process.

Moreover, like shown above, the mail transceiver (10) can provide the pending list for the e-mail stored in the temporary storage (20) to each recipient. At this time, if the corresponding recipients select storing of a particular e-mail of the stored e-mail from the pending list, the mail transceiver (10) transmits the selected e-mail to the recipients' mail accounts of the mail server (200). Consequently, the selected e-mail is not deleted regardless of the response for the authentication mail in the steps ‘ST250’ and ‘ST260’, and the recipients can quickly receive and check required e-mail prior to the sender's response for the authentication mail. And, for a sender of the selected e-mail, it is needless to say that an e-mail address is automatically added to the authenticator list.

Meanwhile, in case the system (100) for blocking spam mail in accordance with the present invention is also applied to the mail server (300) of the sender, that is, when the system (100) for blocking spam mail is comprised on a front end of the mail server (300), the system for blocking spam mail in the sender side can also perform sender authentication through authentication mail for received e-mail. That is to say, given that a mail server of recipients is called ‘mail server A’ and a mail server of the sender is called ‘mail server B’, and if general e-mail (hereinafter, called ‘general mail’) is transmitted from the mail server B, the system (100, system A for blocking spam mail) for blocking spam mail of the mail server A retrieves the authenticator list (30), and transmits an authentication mail A1 for the general mail if the sender does not exist in the authenticator list. In this case, the authentication mail A1 is transmitted, and the sender of the authentication mail A1 will be either e-mail addresses (recipient ID@domain of the mail server A) of the recipients (account users of the mail server A) or a special operation account (for example, webmaster@domain of the mail server A). Therefore, the system (100, system B for blocking spam mail) for blocking spam mail of the mail server B also recognizes the authentication mail A1 as general mail and retrieves the authenticator list (30). If the sender does not exist, the system transmits an authentication mail B1 to the mail server A. As a result, it may occur a looping phenomenon that authentication mail such as A2, B2, A3, B3, . . . is indefinitely transceived between the system A for blocking spam mail and the system B for blocking spam mail.

From now on, an embodiment for receiving authentication mail by distinguishing the authentication mail from general mail between spam mail blocking systems will be described, in order to prevent unlimited transmission of the authentication mail like above.

### EMBODIMENT 1

A first embodiment for preventing the unlimited transmission of the authentication mail is to enable the system (100) for blocking spam mail, more specifically, the mail transceiver (10) to distinguish authentication mail from general mail, by generating the authentication mail in distinguishable particular type or inserting predetermined identification information into the authentication mail. Desirably, the identification information generated by regular rules is inserted into a header of the authentication mail. E-mail consists of a header and the text. Information such as a title of the e-mail, a sender, recipients, and a received date is recorded in the header. In this case, since the identification information capable of distinguishing the authentication mail from the general mail is inserted into the header of the authentication mail, the system (100) for blocking spam mail can distinguish the authentication mail and transmit the authentication mail to a mail account of the sender without a separate authentication process.

For example, if a title of general mail transmitted from the system B for blocking spam mail is ‘Hello!’, a title of the authentication mail A1 transmitted from the system A for blocking spam mail will be transmitted in ‘Re: Hello! 1ksij334kskfd’ type. At this point, the ‘1ksij334kskfd’ of the authentication mail title is identification information showing that the e-mail is the authentication mail. In the meantime, it is desirable to generate the identification information by an encoding module of the system A for blocking spam mail itself, and the authentication processor of the system A for blocking spam mail transmits the authentication mail A1 by inserting the identification information into the title of the authentication mail A1.

Hence, the system B for blocking spam mail decodes the ‘1ksij334kskfd’ to decide that the e-mail is the authentication mail, and transmits the authentication mail A1 to the mail account of the sender of the mail server B without an authentication process of retrieving the authenticator list (30) and transmitting the authentication mail B1. In this case, the decoding of the identification code will be performed by a decoding module of the system for blocking spam mail itself.

### EMBODIMENT 2

A second embodiment for preventing the unlimited transmission of the authentication mail is to include a communication process of notifying that mail to be transmitted is authentication mail, before sending the authentication mail B1 to the system A for blocking spam mail from the system B for blocking spam mail, by partially modifying a public mail MTA (Mail Transfer Agent) which is currently used. To do this, a protocol for distinguishing authentication mail from general mail with a mail server where the sender is registered is inserted into a front end of a protocol for sender/recipient mail account confirmation among mail transfer protocols commonly used during e-mail transceiving. More specifically, said protocol for the communication process is transparently inserted into a front end of an SMTP (Simple Mail Transfer Protocol) and an ESMTP (Extended Simple Mail Transfer Protocol).

Generally, SMTP and ESMTP sessions for transceiving mail transceive e-mail after passing through a process of confirming mail accounts of sender/recipient in order to transceive the mail each other.

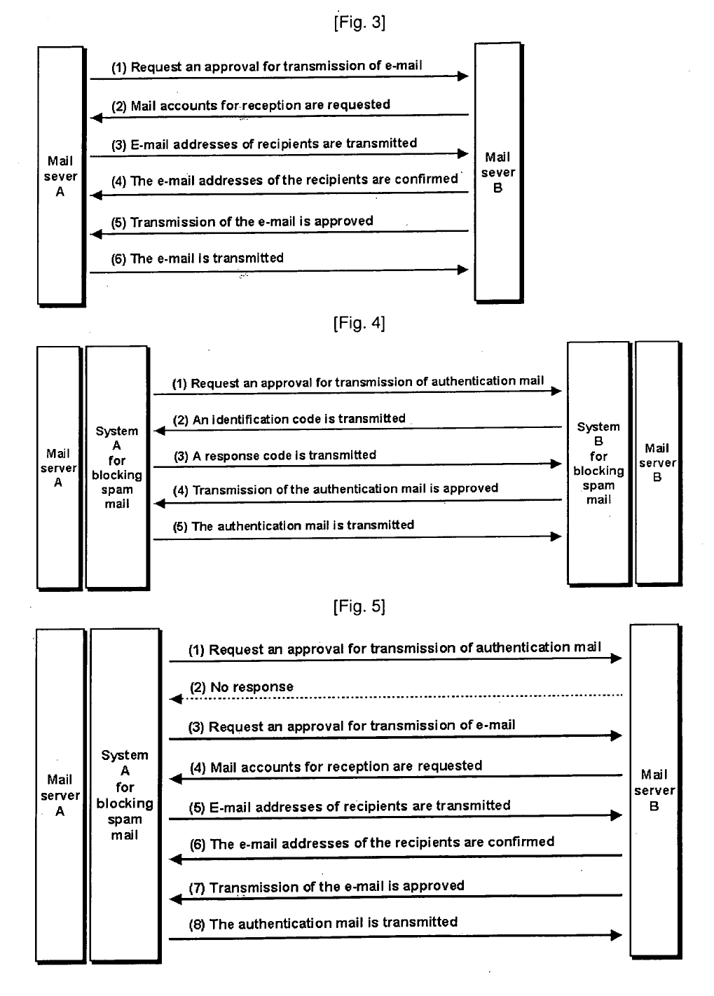

First, a mail transceiving process in the general SMTP and ESMTP sessions will be described in reference to FIG. 3. Generally, in case e-mail is transmitted to a mail server B from a mail server A, substantial e-mail is transmitted after passing through a process of confirming an account for receiving the e-mail like shown in FIG. 3. In a concrete way, the transmission of the e-mail is conducted as follows:

Step 1: The mail server A requests the mail server B to approve for transmission of the e-mail. At this time, it is needless to say that a code for identifying the mail server A is transmitted together with the request message.

Step 2: The mail server B requests mail accounts (recipients' e-mail addresses) for receiving the e-mail. In this case, a code for identifying the mail server B is also transmitted together with the request message.

Step 3: The mail server A transmits the recipients' e-mail addresses.

Step 4: The mail server B confirms whether the e-mail addresses received in the step 3 exist. If the corresponding e-mail addresses do not exist, the mail server B transmits an error message to the mail server A.

Step 5: If the received e-mail addresses are accounts registered in the mail server B, the mail server B approves of e-mail transmission of the mail server A.

Step 6: The mail server A transmits substantial e-mail to the mail server B.

Thus, the system for blocking spam mail in accordance with the present invention inserts the communication process of notifying that the authentication mail is transmitted, prior to the step 1.

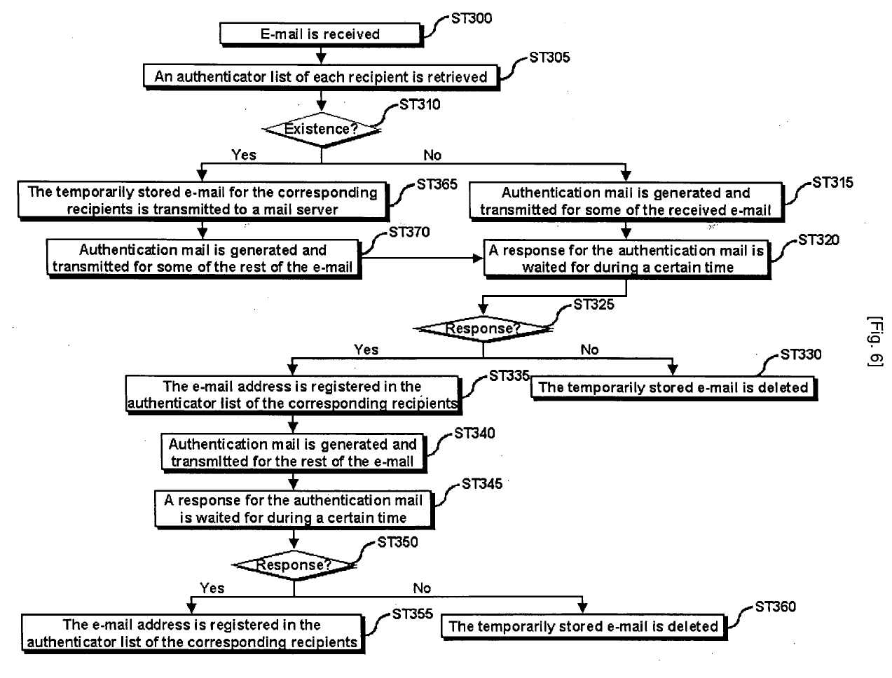

FIG. 4 and FIG. 5 are diagrams for illustrating a process of transceiving authentication mail in accordance with the present invention, FIG. 4 is a diagram for illustrating a process of transceiving the authentication mail between systems for blocking spam mail, and FIG. 5 is a diagram for illustrating a process of transceiving the authentication mail between a system for blocking spam mail and a mail server. Also, FIG. 4 and FIG. 5 show a case the authentication mail is transmitted to a mail server B from a mail server A.

First, in reference to FIG. 4, a case the systems for blocking spam mail are applied to both mail server A and mail server B will be described as follows.

Step 1: A system A for blocking spam mail requests a system B for blocking spam mail to approve for transmission of the authentication mail. In this case, it is needless to say that a special code for identifying the system A for blocking spam mail can be transmitted as well.

Step 2: The system B for blocking spam mail transmits an identification code for verifying transmission of the authentication mail. At this time, it is needless to say that a special code for identifying the system B for blocking spam mail can be transmitted as well;

Step 3: The system A for blocking spam mail transmits a response code for the identification code received in the step 2.

Step 4: The system B for blocking spam mail checks whether the response code transmitted in the step 3 is appropriate for the identification code, and approves of the transmission of the authentication mail.

The identification code and the response code in the steps 2 and 3 are key values in a pair, and can be generated by certain rules. In other words, they are generated by code generation rules shared between the system A for blocking spam mail and the system B for blocking spam mail. For example, it is available to realize, on an MTA, communication rules that a code consisting of 3 alphabets and 2 numerals is transmitted as an identification code while a code consisting of the next 3 alphabets after one of the above 3 alphabets and 2 numerals which make 10 with the above 2 numerals, is transmitted as a response code. In this case, if ‘cbd27’ is transmitted as the identification code while ‘edf83’ is transmitted as the response code, the system B for blocking spam mail considers e-mail which is next transmitted as authentication mail since the response code is a proper code, and receives the mail without authentication.

Step 5: The system A for blocking spam mail transmits the authentication mail to the system B for blocking spam mail.

Meanwhile, it is also possible to further comprise a step (step 3 to step 5 of FIG. 3) of confirming whether e-mail addresses of recipients (senders of general mail) who will receive the authentication mail are registered in the mail server B in the step 4.

Next, in reference to FIG. 5, a case the authentication mail is transceived between a system for blocking spam mail and a general mail server will be described as follows. In FIG. 5, a mail server A is a mail server applied with a system A for blocking spam mail in accordance with the present invention, and a mail server B is a general mail server to which a system for blocking spam mail is not applied.

Step 1: The system A for blocking spam mail requests the mail server B to approve for transmission of the authentication mail. In this case, a special code for identifying the system A for blocking spam mail is transmitted as well.

Step 2: Since communication (message) received in the step 1 is not transceived in general SMTP and ESMTP sessions, the mail server B does not respond to the message.

If the response is not received from the mail server B, the system A for blocking spam mail decides the mail server B as a general mail server, and transmits the authentication mail through the general SMTP and ESMTP sessions. Namely, the authentication mail is transmitted according to a process of transmitting general e-mail.

Step 3: The system A for blocking spam mail requests the mail server B to approve for transmission of e-mail. At this time, a code for identifying the system A for blocking spam mail is transmitted as well.

Step 4: The mail server B demands mail accounts for receiving the e-mail. At this moment, a code for identifying the mail server B is transmitted as well.

Step 5: The system A for blocking spam mail transmits e-mail addresses for receiving the e-mail.

Step 6: The mail server B confirms whether the e-mail addresses received in the step 5 exist.

Step 7: The mail server B approves of transmission of the e-mail of the system A for blocking spam mail.

Step 8: The system A transmits authentication mail as the e-mail. In the meantime, when the authentication mail is transmitted to a sender who has sent the e-mail and the sender is authenticated according to the sender's response, if a substantial sender of the e-mail is not the sender mentioned above, that is, if a spammer or a malicious sender transmits the e-mail through an e-mail address of a third party, there may cause a problem that a lot of authentication mail is transmitted to the third party. For instance, if a spammer having an e-mail address ‘a@a.com’ transmits a great deal of e-mail to a plurality of recipients having mail accounts on a mail server C (c.com) by setting an e-mail address ‘b@b.com’ of a third party to a sender, and if the system (100) for blocking spam mail in accordance with the present invention is applied to the mail server C, authentication mails are transmitted to the e-mail address b@b.com as much as the quantity of the transmitted e-mail. In such a case, the same amount of authentication mail is transmitted when a lot of e-mail is transmitted to one recipient as well as when there exist a lot of recipients like above. Given that the mail server restricts the maximum amount of received e-mail, which the server can handle at a time, to 256 pieces of mail even though a large quantity of e-mail is received at the same time, the user of the mail account ‘b@b.com’ may unnecessarily receive 256 pieces of authentication mail. Therefore, when transmitting authentication mails for received e-mails, the system (100) for blocking spam mail in accordance with the present invention primarily transmits authentication mails for some of the e-mails without sending the authentication mails at a time for e-mails transmitted from the same sender, and transmits authentication mails for the rest of the e-mails or deletes the e-mails according to the sender's response. From now on, a 2-step transmission process of authentication mails will be fully described below.

FIG. 6 is a flow chart showing a process of transmitting authentication mails by dividing the authentication mails in 2 stages. FIG. 6 supposes a case a lot of e-mail is received from the same sender at a time. In reference to FIG. 6, the process of transmitting the authentication mails by dividing the authentication mails in the 2 stages will be described as follows.

When e-mails are transmitted from the mail server (300), the mail transceiver (10) receives the e-mails (ST300).

The authentication processor (40) retrieves whether a sender of the e-mails is included in the authenticator list (30) (ST305). At this point, if the received e-mail is transmitted for a plurality of recipients, it is retrieved whether a sender of the e-mails is included in the authenticator list of each recipient.

If the authenticator list in which an e-mail address of the sender is registered does not exist, the authentication processor (40) generates authentication mail for some of the e-mails among the received e-mails, and transmits the generated authentication mail (ST310, ST315). Desirably, the authentication mail is transmitted for the predetermined quantity of the e-mails in reception order of the e-mails. For example, if 256 pieces of e-mail having 256 mail account registers as recipients are received, authentication mail is transmitted for first 2 pieces of the received e-mail. On this occasion, the mail transceiver (10) stores the received e-mails in the temporary storage (20). Hereinafter, some of the selected e-mail is called ‘first e-mail’, and authentication mail transmitted for the first e-mail is called ‘first authentication mail’.

The authentication processor (40) waits for the sender's response for the first authentication mail during a preset time (ST320).

If the response is not received from the sender during the set time, that is to say, if the sender does not respond by accessing the authentication processor (40) through access information included in the first authentication mail within the set time, the authentication processor transmits a message indicative of authentication failure to the mail transceiver (10), and the mail transceiver deletes all of the e-mail stored in the temporary storage (20) (ST325, ST330). In other words, the sender is considered as a spam mail sender in the above example, thus among the e-mails transmitted from the sender, not only the 2 pieces of the first e-mail to which the first authentication mail is transmitted, but also the rest of the 254 pieces of the e-mail to which the authentication mail is not transmitted are deleted without sending the authentication mail.

On the contrary, if the response is received from the sender within the set time, that is, if the sender accesses the authentication processor (40) through the access information of the first authentication mail and inputs an answer for a question or character patterns, the authentication processor registers the e-mail address of the sender in the authenticator list (30) of the corresponding recipients (ST325, ST335). In this case, it is to be sure that the mail transceiver (10) transmits the first e-mail of the e-mail stored in the temporary storage (20) to mail accounts of the corresponding recipients of the mail server (200). Besides, the authentication processor (40) generates authentication mail for the rest of the e-mail except the first e-mail among the e-mail transmitted by the sender, and transmits the generated authentication mail (ST340). Now, the rest of the e-mail except the first e-mail are called ‘second e-mail’, and authentication mail transmitted for the second e-mail is called ‘second authentication mail’.

The authentication processor (40) waits for the sender's response for a set time according to each of the second authentication mail, and registers the e-mail address of the sender in the authenticator list (30) of the corresponding recipients with regards to one of the second authentication mail, on which the response is received, then the mail transceiver (10) transmits each of the corresponding second e-mail to the mail accounts of the recipients of the mail server (200) from the temporary storage (20) (ST345 to ST355). On the contrary, with regards to the other one of the second authentication mail on which the response is not received for the set time, the mail transceiver (10) deletes the second e-mail stored in the temporary storage (20) (ST350, ST360).

Meanwhile, if there exist recipients of the sender of the e-mail who is registered in the authenticator list (30) as the retrieved results of the step ‘ST305’, the mail transceiver (10) transmits the received e-mail to mail accounts of the corresponding recipients of the mail server (200) (ST310, ST365). Also, the rest of the e-mail which are not included in the authenticator list (30) of each recipient are stored in the temporary storage (20), and authentication mail is generated and transmitted for some of the rest of the e-mail, then the rest of the e-mail is transmitted to the mail server (200) or deleted according to the sender's response (ST370, ST320 to ST360).

On the other hand, it is to be sure that the e-mails stored in the temporary storage (20) are provided to each recipient through a pending list like above, and each recipient selectively receives the e-mail stored in the temporary storage through the pending list, and registers the sender in the authenticator list (30). In a concrete way, recipients can confirm and receive even the e-mail to which the authentication mail is not transmitted in the steps ‘ST315’ and ‘ST370’ as well as the e-mail to which the authentication mail is transmitted in the steps ‘ST315’, ‘ST340’ and ‘ST370’. Consequently, it is possible to prevent the e-mail, to which the authentication mail is not transmitted, from being received to the recipients by being excessively delayed in the steps ‘ST315’ and ‘ST370’.

Meanwhile, if an amount of received e-mail is much when the received e-mail is authenticated through the authentication mail, it may cause overload as system resources are wasted, since the authentication mail is individually transmitted. Also, even in case an amount of received e-mail is little, the system resources are unnecessarily wasted as well. Furthermore, since a large quantity of authentication mail is transmitted to a mail server of the other party, an overload may occur in the mail server of the other party. Thus, for a lot of received e-mail, the system (100) for blocking spam mail in accordance with the present invention manages an e-mail address, an IP address or domain of a sender of e-mail which is clearly defined as spam mail, as a blacklist, and blocks that e-mail transmitted from the e-mail address, the IP address or domain included in the blacklist is received to the mail transceiver (10), and deletes the e-mail. From now on, a process of blocking spam mail by using the blacklist will be described below.

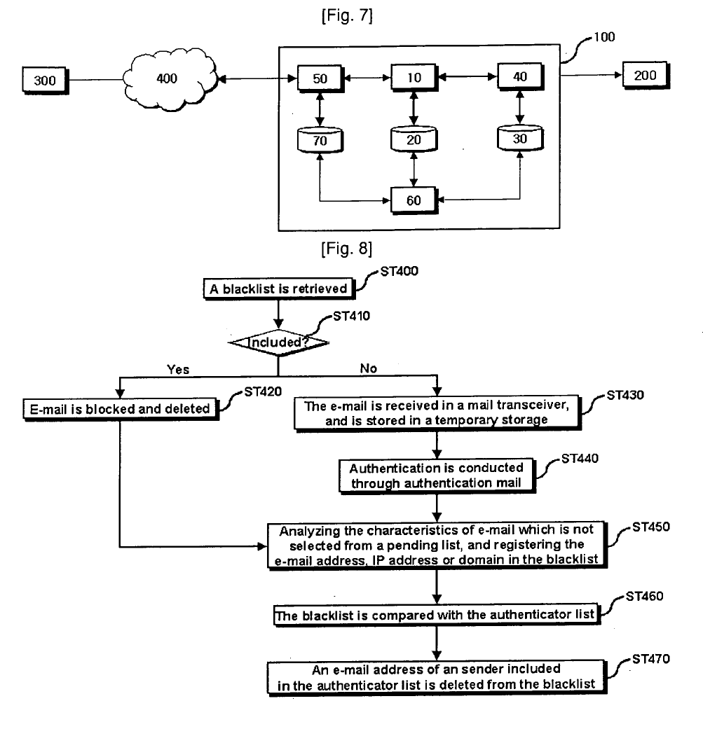

FIG. 7 is a format diagram of another embodiment of a system for blocking spam mail in accordance with the present invention, illustrating an embodiment that spam mail is primarily filtered by using a blacklist (70) and the rest of e-mail is authenticated through authentication mail. Like shown in FIG. 7, a system (100) for blocking spam mail in accordance with the present invention, comprising: a blacklist blocker (50) blocking e-mail included in the blacklist (70) among a lot of e-mail received from a mail server (300); a mail transceiver (11) receiving the e-mail which passes through the blacklist blocker; a temporary storage (20) temporarily storing the received e-mail; an authenticator list (30) storing a list of a sender authenticated by the system (100) for blocking spam mail; an authentication processor (40) authenticating the sender of the e-mail by using authentication mail; a blacklist processor (60) generating and managing the blacklist by linking with the temporary storage, a pending list, and the authenticator list; and the blacklist (70) storing a list of an e-mail address, an IP address or domain of the sender whose e-mail is to be blocked. Now, each configuration part of the system (100) for blocking spam mail will be described below, while some parts overlapped with the above contents will be omitted.

The blacklist (70) in accordance with the present invention refers to a list of an e-mail address, an IP address or domain of a sender whose e-mail will be blocked not to be transmitted to entire users of a mail server (200), that is, entire recipients. The blacklist (70) is a list of an e-mail address, an IP address or domain of a sender decided as a sender of clear spam mail which the entire recipients of the mail server (200) do not want to receive, and any e-mail transmitted from the e-mail address, the IP address or domain included in the blacklist is blocked by the blacklist blocker (50). Unlike the authenticator list (30) and the pending list, the blacklist (70) is generated and managed in mail server unit. In addition, the blacklist (70) is generated and managed by the blacklist processor (60).

The blacklist blocker (50) is disposed on a front end of the mail transceiver (10), and blocks/deletes the e-mail included in the blacklist (70), that is, blocks/deletes reception of the e-mail transmitted from the e-mail address, the IP address or domain included in the blacklist, among e-mail received to the mail server (200). As stated above, since the blacklist (70) indicates the e-mail address of the sender, at which all of the recipients registered in the mail server (200) do not want to receive e-mail, that is, indicates the e-mail address, the IP address or domain of the sender confirmed as the sender of the clear spam mail, it may cause system resources to be unnecessarily wasted in the mail server (300) of the other party as well as in the mail server (200) if authentication mail f or the above e-mail is transmitted. So, after the blacklist blocker (50) blocks the e-mail included in the blacklist (70), the mail transceiver (10) receives the rest of the e-mail only and carries out authentication through the authentication mail, thereby tremendously saving the system resources while improving processing efficiency of the e-mail.

The blacklist processor (60) in accordance with the present invention generates and manages the blacklist (70) by linking with the temporary storage (20) and the pending list. The blacklist processor (60) analyzes and compares each characteristic of e-mail, which is not stored through the pending list by all of the recipients of the e-mail, among the e-mail temporarily stored in the temporary storage (20) for a set period after the authentication processor (40) transmits the authentication mail, and registers an e-mail address, an IP address or domain of a sender of e-mail having the same characteristics, in the blacklist (70). In this case, before registering the e-mail address, the IP address or domain of the sender in the blacklist (70), the blacklist processor (60) retrieves the authenticator list (30) so that an e-mail address, an IP address or domain of a sender included in the authenticator list are not registered in the blacklist. The characteristics analyzed by the blacklist processor (60) include the e-mail address of the sender, a sending IP of the e-mail, a title of the e-mail, and the contents of the text of the e-mail, and also, it is possible to compare and analyze various characteristics in addition to the above characteristics. If there exists a lot of e-mail having one identical characteristic from the e-mail address of the same sender, IP, title, and the contents of the text, among the separate e-mail registered in the pending list and stored in the temporary storage (20), and if all of the recipients do not store the above e-mail through the pending list, the blacklist processor (60) registers the e-mail address, the IP address or domain of the sender of the corresponding e-mail, in the blacklist (70). More detailed explanations on each characteristic will be shown as follows.

First, in case of analyzing the e-mail address of the sender, e-mail addresses of senders of e-mail stored in the temporary storage (20) are compared. If there exists a lot of e-mail transmitted from the same e-mail address of the sender and if all of the recipients of the e-mail sent by the sender do not store the e-mail of the sender through the pending list for a storage period of the temporary storage, the blacklist processor (60) registers an e-mail address, an IP address or domain of the sender of the corresponding e-mail, in the blacklist (70). Desirably, the e-mail is ranked by reflecting the quantity of the transmitted e-mail, the storage period, and the frequency (times) of transmitting such e-mail, then the sender having more than certain ranking is included in the blacklist (70). For example, if the recipients do not store e-mail of both sender A and sender B from the pending list though the sender A transmits 100 pieces of e-mail and the sender B transmits 10 pieces of e-mail, the sender A is included in the blacklist (70) by being ranked more highly than the sender B. On the other hand, if any one of the recipients of the e-mail stores the corresponding e-mail from the pending list, the sender of the corresponding e-mail is not included in the blacklist (70).

Next, in case of analyzing the sending IP of an e-mail, sending IPs of the e-mail stored in the temporary storage (20) are compared. If there exists a lot of e-mail transmitted from the same sending IP regardless of whether the e-mail address of the sender is the same and if all of the recipients of the corresponding e-mail do not store the above e-mail through the pending list, all e-mail addresses, IP addresses or domains of the sender of the corresponding e-mail are registered in the blacklist (70). Thus, it is possible to effectively block sent spam mail by using an automatic e-mail generator for virtually and automatically generating e-mail addresses of senders and automatically sending e-mail to the same or a plurality of recipients. Also, in case of analyzing the title of the e-mail or the contents of the text of the e-mail, titles of the e-mail stored in the temporary storage (20) or the contents of the text of the e-mail are compared and analyzed together. If there exists a lot of e-mail having the same title or the same contents regardless of whether an e-mail address of a sender or a sending IP is the same and if all of the recipients of the corresponding e-mail do not store the e-mail through the pending list during the storage period of the temporary storage, the e-mail addresses, the IP addresses or domains of the sender of the corresponding e-mail are registered in the blacklist (70). Particularly, in case of analyzing the contents of the text of separate e-mail, the contents of the text of the e-mail are hashed (hashing) and converted into codes, then the converted codes are compared together to decide identity of the codes. Also, in case of analyzing the sending IP, the title or the contents of the text, they are ranked as well. Then, more than certain ranking is registered in the blacklist, and if there exists e-mail stored by the recipients among the corresponding e-mail, the stored e-mail is not registered in the blacklist.

Likewise, if the e-mail address, the IP address or domain included in the blacklist (70) are contained in the authenticator list, the blacklist processor (60) in accordance with the present invention deletes the corresponding e-mail address, IP address or domain from the blacklist, by linking with the authenticator list (30). The blacklist processor (60) compares the blacklist (70) with the authenticator list (30) of each recipient at certain intervals. Desirably, when the authenticator list (30) of each recipient is updated, for instance, if a recipient includes a new e-mail address in the authenticator list or stores e-mail from the pending list, or if a sender is authenticated through authentication mail, the blacklist processor (60) compares the blacklist (70) with the updated authenticator list. Accordingly, for the e-mail which even one recipient wants to receive, the corresponding e-mail is received without being blocked by the blacklist blocker (50), so that each recipient can selectively receive the corresponding e-mail. As a result, it is available to prevent essential e-mail from being lost and to operate the blacklist according to characteristics of each recipient, thereby efficiently blocking spam mail without damaging to the recipients.

FIG. 8 is a flow chart showing a spam mail blocking process using a blacklist in accordance with the present invention. Referring to FIG. 8, the spam mail blocking process using the blacklist in accordance with the present invention will be described below.

When e-mail is transmitted from the mail server (300), the blacklist blocker (50) retrieves whether a sender of the e-mail is included in the blacklist (70) (ST400). In other words, an e-mail address, an IP address or domain of the sender of the e-mail are retrieved from the blacklist.

If the sender of the corresponding e-mail is included in the blacklist (70) as the retrieved results of the step ‘ST400’, the blacklist blocker (50) blocks and deletes the e-mail (ST410, ST420).

If the sender of the corresponding e-mail is not included in the blacklist (70) as the retrieved results of the step ‘ST400’, the blacklist blocker (50) passes the corresponding e-mail, and the e-mail is received in the mail transceiver (10), then is stored in the temporary storage (20) (ST410, ST430).

The authentication processor (40) conducts authentication through authentication mail for the e-mail stored in the temporary storage (20) (ST440). Concretely, the authentication process of the steps ‘ST210’ to ‘ST280’ of FIG. 2 or the authentication process of the steps ‘ST305’ to ‘ST370’ of FIG. 6 are carried out.

Apart from the authentication process for the e-mail in the authentication processor (40), the blacklist processor (60) manages the blacklist (70) by adding or deleting the e-mail address, the IP address or domain of the sender in the blacklist (70) by linking with the temporary storage (20), the pending list, and the authenticator list (30).

First, the blacklist processor (60) analyzes characteristics of e-mail which is not selected from the pending list until a set storage period elapses, among the e-mail stored in the temporary storage (20) by being transmitted to each recipient of the mail server (200), and registers an e-mail address, an IP address or domain of a sender of e-mail having the same characteristics, in the blacklist (70) (ST450). More specifically, if there is no authentication for the corresponding e-mail by the sender and if the recipients do not store the e-mail from the pending list until the period set to store the e-mail in the temporary storage elapses, the blacklist processor (60) analyzes the characteristics of the corresponding e-mail, and registers certain e-mail in the blacklist (70), in spite of the fact that a list of the e-mail stored in the temporary storage (20) is provided as the pending list after the authentication mail is transmitted. In this case, since the above e-mail is not authenticated by the sender and also the recipients do not want to receive the e-mail, there is high probability that the e-mail is spam mail. So, after the characteristics are analyzed, the e-mail is registered in the blacklist. Like shown above, the analyzed characteristics of the e-mail include the e-mail address of the sender, a sending IP of the e-mail, a title of the e-mail, and the contents of the text of the e-mail. The blacklist processor (60) compares/analyzes characteristics of the e-mail address of the sender, the sending IP, the title, and the contents of the text, for separate e-mail which is not stored by the recipients through the pending list after being stored in the temporary storage (20). At this time, if there exists a lot of e-mail transmitted from the same e-mail address of the sender, e-mail transmitted from the same sending IP, e-mail having the same title, or e-mail having the same contents of the text, the blacklist processor (60) considers the corresponding e-mail as clear spam mail, and registers the e-mail address, the IP address or domain of the sender in the blacklist (70). Desirably, a probability of spam mail is ranked in consideration of the quantity, a storage period, and the frequency of transmission of e-mail having the same characteristics, then a sender for some high-ranking e-mail is included in the blacklist (70). Moreover, the blacklist processor (60) retrieves the e-mail address, the IP address or domain of the sender to be registered in the blacklist (70), from the authenticator list (30) of each recipient registered in the mail server (200), and registers the e-mail address, the IP address or domain of the sender in the blacklist only when an authenticator list containing the corresponding e-mail address, IP address or domain does not exist. Therefore, only when all of the recipients registered in the mail server (200), who have received the e-mail from the corresponding sender, do not want to receive the e-mail, the sender is registered in the blacklist (70). Consequently, it is possible to block e-mail only, which is transmitted from a clear spammer, preventing damage of recipients and a well-intended sender.

Besides, the blacklist processor (60) compares the authenticator list (30) with the blacklist (70) at certain intervals, and if one of the e-mail address, the IP address or domain of the sender included in the blacklist is included in the authenticator list, the blacklist processor (60) deletes the included value from the blacklist (ST460, ST470). Desirably, when the authenticator list (30) of each recipient is updated, the blacklist processor (60) compares the updated authenticator list with the blacklist to decide whether a commonly included an e-mail address, an IP address or domain exist, and deletes the e-mail address, the IP address or domain, which are included in both authenticator list and the blacklist, from the blacklist. A case the authenticator list (30) is updated includes a case each recipient registers a new e-mail address in the authenticator list, a case each recipient stores e-mail from the pending list, and a case the sender conducts authentication through the authentication mail. Accordingly, it is possible to prevent the sender, from whom the recipients want to receive e-mail, from being registered in the blacklist (70), and such a process may be executed in real time, thus it can prevent desired e-mail from being blocked.

### INDUSTRIAL APPLICABILITY

As stated so far, a system for blocking spam mail and a method of the same in accordance with the present invention can effectively block the spam mail by authenticating a sender of e-mail through a response for authentication mail, and can also distinguish the authentication mail from general mail between systems for blocking spam mail, thereby preventing the authentication mail from being repeatedly transceived, while showing a remarkable effect of preventing unexpected damage caused when a lot of authentication mail is transmitted to a third party in case a spammer transmits the large quantity of the authentication mail by using an e-mail address of the third party.

In other words, the system for blocking spam mail and the method of the same in accordance with the present invention have the following benefits:

(1) Since authentication mail is transmitted to a sender for e-mail transmitted from an unregistered e-mail address and the sender is authenticated depending on whether a response for the authentication mail is received, it is possible to effectively block spam mail which is transmitted to many and unspecified persons in large quantities and spam mail which is transmitted from randomly generated virtual e-mail addresses;

(2) Since e-mail, which is transmitted from an authenticated sender only, is received, it is available to tremendously reduce resource consumption and an unnecessary waste of time of a recipient for processing spam mail;

(3) Since a spam mail blocking function is handled in a sender side instead of a recipient side of e-mail, it is available to prevent an unnecessary waste of resources of a mail system of the recipient side;

(4) Since a special identification code capable of identifying authentication mail is inserted into a title of the authentication mail, the system for blocking spam mail which receives the authentication mail can decide e-mail as the authentication mail instead of general e-mail, thereby preventing the authentication mail from being repeatedly transceived between systems for blocking spam mail;

(5) A protocol communicated to allow systems for blocking spam mail to mutually distinguish transmission of authentication mail is inserted into a front end of SMTP and ESMTP session generally used for transceiving e-mail, thus a mail system which receives the authentication mail can distinguish received e-mail as the authentication mail, prohibiting a repeated transceiving process of the authentication mail;

(6) The above communicating process is transparently inserted into the front end of the SMTP and ESMTP sessions to distinguish the authentication mail, so that the authentication mail can be handled without disturbing the SMTP and ESMTP sessions, therefore it is also applicable to a case authentication mail is transmitted to a general mail server, as well as it is possible to prevent a spammer or a hacker from hacking or recognizing the contents of the communicating process;

(7) Since it is sufficient that only confirmable communicating rules is shared between systems for blocking spam mail by partially adjusting MTA, the present invention can be easily compatible between the system for blocking spam mail and the mail server;

(8) Because a pending list which is a list of e-mail stored in a temporary storage is provided to each recipient before a response for authentication mail is received and the e-mail is transmitted to mail accounts of each recipient of a mail server from the temporary storage while a sender is not authenticated according to selection of the recipients, it is possible to quickly confirm the e-mail irrespective of whether the sender is authenticated or not, and to prevent the e-mail from being lost even when the sender does not respond to the authentication mail by mistake;

(9) Authentication mail is transmitted in 2 stages for a lot of e-mail transmitted by the same sender, so it can prevent generation of damage that a large quantity of authentication mail is unnecessarily transmitted to a third party by a spammer who generates spam mail by using an e-mail address of the third party;

(10) An e-mail address, an IP address or domain of a sender whose e-mail is not desired by All recipients registered in a mail server is managed as a blacklist, and e-mail transmitted from an e-mail address, an IP address or domain included in the blacklist is blocked in: a previous step of reception in a mail transceiver, so that reception and authentication of unnecessary e-mail can be omitted, therefore it is possible to prevent system resources from being wasted while a processing efficiency may be improved, as well as it is available to prevent an overload of a system, which is caused when unnecessary authentication mail is transmitted to a mail server of the other party in large quantities;

(11) The sender is registered in a blacklist, only when all recipients registered in a mail server do not want to receive the e-mail from the corresponding sender, thus it can prevent essential e-mail from being lost so as to prevent damage of the recipients and a well-intended sender, and since the blacklist is also compared and updated in real time while an authenticator list is updated, it is possible to prevent a desired sender of the recipients who want to receive e-mail of the sender, from being registered in the blacklist, thereby providing the blacklist in consideration of characteristics of the whole recipients of the mail server; and

(12) It is also applicable to other mail system using an authentication method through authentication mail, thereby realizing large expandability.

In the drawings and specification, there have been disclosed typical preferred embodiments of the invention and, although specific terms are employed, they are used in a generic and descriptive sense only and not for purposes of limitations, the scope of the invention being set forth in the following claims.

1. A system for blocking spam mail located on a front end of a mail server which transceives e-mail, transmitting authentication mail for authenticating a sender to an e-mail address of the sender who sends e-mail, authenticating the sender depending on whether the sender responds to the authentication mail, and processing reception/deletion of the e-mail, comprising:
a mail transceiver receiving the e-mail, temporarily storing the e-mail in a temporary storage for a set time after the authentication mail is transmitted, deleting the e-mail if the sender's response is not received within the set time, and transmitting the temporarily stored e-mail to mail accounts of recipients of the mail server if the sender's response is received within the set time;
an authenticator list classifying and storing, according to each recipient, the e-mail address of the sender authenticated through the authentication mail and an e-mail address of a random sender registered by the recipients of the e-mail to receive the e-mail without authentication; and
an authentication processor retrieving whether the e-mail address of the sender is included in the authenticator list, sending the authentication mail to the e-mail address of the sender if the e-mail address of the sender is not included in the authenticator list, and authenticating the sender according to the sender's access and response for the authentication mail.

2. The system for blocking spam mail of claim 1, wherein the authentication mail includes predetermined identification information for distinguishing the authentication mail from general e-mail, in a header of the authentication mail.

3. The system for blocking spam mail of claim 1, wherein the system for blocking spam mail performs a protocol for distinguishing the authentication mail from general e-mail with the mail server in which the sender is registered, on a front end of a protocol for sender/recipient mail account confirmation among mail transfer protocols.

4. The system for blocking spam mail of claim 1, wherein the mail transceiver provides a pending list linked with the temporarily stored e-mail so that the recipients can select, receive, and store the e-mail temporarily stored in the temporary storage.

5. The system for blocking spam mail of claim 4, wherein the mail transceiver transmits the e-mail selected by the recipients from the pending list to the mail accounts of the recipients of the mail server irrespective of the response for the authentication mail; and
the authentication processor adds the e-mail address of the sender for the e-mail selected by the recipients from the pending list to the authenticator list.

6. The system for blocking spam mail of one of claims 1 to 5, wherein the authentication mail includes access information that includes a URL for the sender to access the authentication processor, and a unique key for authenticating the sender; and
the authentication processor stores the unique key and an equivalent key value for verifying the sender's response for the unique key, then authenticates the sender by confirming the sender's access through the authentication mail and comparing the sender's response for the unique key with the key value.

7. The system for blocking spam mail of one of claims 1 to 5, wherein the authentication mail contains the access information that includes the URL for the sender to access the authentication processor; and
the authentication processor displays special character patterns processed in graphics on a web page linked with the access information, and inputs the special character patterns from the sender to authenticate the sender.

8. The system for blocking spam mail of one of claims 1 to 5, wherein the authentication mail contains the access information that includes the URL for the sender to access the authentication processor; and
the authentication processor provides a question with an answer on the web page linked with the access information, and inputs an answer from the sender to authenticate the sender depending on whether the answer of the sender is correct.

9. The system for blocking spam mail of claim 4, wherein the system for blocking spam mail, comprising:
a blacklist storing an e-mail address or an IP address of a sender, wherein all of the recipients registered in the mail server refuse to receive the e-mail transmitted from the sender;
a blacklist processor liking with the temporary storage, the pending list, and the authenticator list, and registering the e-mail address or the IP address of the sender of e-mail having the same characteristics by comparing each characteristic of each of the e-mail, which all of the recipients of the e-mail do not receive through the pending list, among the e-mail temporarily stored in the temporary storage during the set time, then comparing the blacklist with the authenticator list in real time to delete the e-mail address of the sender, which is commonly included in the blacklist and the authenticator list, from the blacklist; and
a blacklist blocker located on a front end of the mail transceiver, and blocking the reception of the e-mail transmitted from the e-mail address or IP address included in the blacklist among the received e-mail.

10. The system for blocking spam mail of claim 9, wherein the characteristics compared by the blacklist processor include the e-mail address of the sender, a sending IP, a title of the e-mail, and the contents of the text of the e-mail.

11. A method of blocking spam mail for transmitting authentication mail for authenticating a sender to an e-mail address of the sender who sends e-mail, on a front end of a mail server A which transceives the e-mail, authenticating the sender depending on whether the sender responds to the authentication mail, and for transmitting the e-mail of the authenticated sender to recipients, comprising:
a first step of receiving the e-mail;
a second step of retrieving the e-mail address of the sender from an authenticator list which is a list of the e-mail address of the sender whose the e-mail is authenticated and permitted to be transmitted to the recipients;
if the e-mail address of the sender exists in the authenticator list, a third step of transmitting the e-mail to mail accounts of the recipients of the mail server A;
if the e-mail address of the sender does not exist in the authenticator list, a fourth step of transmitting the authentication mail to the e-mail address of the sender, and temporarily storing the e-mail in a temporary storage for a predetermined set time;
if the sender's response for the authentication mail is received within the set time, a fifth step of transmitting the e-mail temporarily stored in the temporary storage to the mail accounts of the recipients of the mail server A, and adding the e-mail address of the sender to the authenticator list; and
if the sender's response for the authentication mail is not received within the set time, a sixth step of deleting the e-mail temporarily stored in the temporary storage; and wherein
the third step and the fourth to sixth steps are selectively carried out while the fifth step and the sixth step are selectively carried out.

12. The method of blocking spam mail of claim 11, wherein the fourth step is composed of:
a 4-1 step of generating predetermined identification information so that a mail server B in which the e-mail address of the sender is registered can distinguish the authentication mail from general e-mail; and
a 4-2 step of inserting the identification information into the authentication mail.

13. The method of blocking spam mail of claim 11, wherein the fourth step is composed of:
a 4-3 step of transmitting a message which demands a transmission permission of the authentication mail to the mail server B in which the e-mail address of the sender is registered; and wherein the 4-3 step can be performed on a front end of a protocol for sender/recipient mail account confirmation among mail transfer protocols, so as to communicate with the mail server B.

14. The method of blocking spam mail of claim 13, wherein after the 4-3 step, the method of blocking spam mail further comprises:
a 4-4 step of which the mail server A receives an identification code transmitted and generated according to certain rules by the mail server B in order to verify transmission of the authentication mail;
a 4-5 step of transmitting response codes, which are generated by the certain rules and key values in a pair for the identification code, to the mail server B; and
a 4-6 step of receiving a message that approves of transmission of the authentication mail from the mail server B.

15. The method of blocking spam mail of one of claims 11 to 14, wherein the authentication mail includes access information that contains a URL for the sender to access a predetermined web page to respond to the authentication mail and a unique key for authenticating the sender; and wherein the fifth step consists of:
a 5-1 step of authenticating the sender by inputting a key value corresponding to the unique key as a response from the sender.

16. The method of blocking spam mail of one of claims 11 to 14, wherein the authentication mail includes the access information that contains the URL for the sender to access the predetermined web page to respond to the authentication mail; and wherein the fifth step consists of:
a 5-2 step of displaying special character patterns processed in graphics on the web page linked with the access information; and
a 5-3 step of authenticating the sender by inputting the special character patterns from the sender.

17. The method of blocking spam mail of one of claims 11 to 14, wherein the authentication mail includes the access information that contains the URL for the sender to access the predetermined web page to respond to the authentication mail; and wherein the fifth step consists of:
a 5-4 step of providing a question with an answer on the web page linked with the access information; and
a 5-5 step of inputting an answer from the sender, and authenticating the sender depending on whether the answer of the sender is correct.

18. The method of blocking spam mail of claim 11, wherein the method of blocking spam mail further comprises:
a seventh step of providing a pending list which is linked with the e-mail to the recipients to check the e-mail temporarily stored in the temporary storage;
an eighth step of transmitting the e-mail selected by the recipients from the pending list to the mail accounts of the recipients of the mail server A, irrespective of the response for the authentication mail; and
a ninth step of adding the e-mail address of the sender to the authenticator list, for the e-mail selected by the recipients from the pending list; and wherein the eighth step and the ninth step are carried out regardless of order while the seventh to ninth steps are carried out with the fourth to sixth steps regardless of order.

19. The method of blocking spam mail of claim 18, wherein the method of blocking spam mail further comprises:
a tenth step of blocking reception of e-mail transmitted from an e-mail address or an IP address included in a blacklist which stores the e-mail address or the IP address of the sender, wherein all of the recipients registered in the mail server A refuse to receive the e-mail transmitted from the sender;
an eleventh step of registering, in the blacklist, the e-mail address or the IP address of the sender of e-mail having the same characteristics, by comparing each characteristic of each of the e-mail that all of the recipients of the e-mail do not select through the pending list in the eighth step and the ninth step, among the e-mail temporarily stored in the temporary storage for the set time in the fourth step; and
a twelfth step of comparing the blacklist with the authenticator list in real time to delete the e-mail address of the sender commonly included in the blacklist and the authenticator list, from the blacklist; and wherein
the tenth step is carried out prior to the first step, and the eleventh step is selectively carried out with the eighth step and the ninth step while the twelfth step is carried out with the first to ninth steps regardless of order.

20. The method of blocking spam mail of claim 19, wherein with regards to each of the e-mail which is not selected by all of the recipients of the e-mail through the pending list in the eighth step and the ninth step among the e-mail temporarily stored in the temporary storage during the set time in the fourth step, the eleventh step includes:
an 11-1 step of comparing the e-mail address of the sender, and if e-mail having the same e-mail address of the sender is in plural, registering the e-mail address of the sender of the e-mail having the same e-mail address of the sender, in the blacklist,
an 11-2 step of comparing a sending IP, and if e-mail having the same sending IP is in plural, registering the IP address of the sender of the e-mail having the same sending IP, in the blacklist;
an 11-3 step of comparing a title of the e-mail, and if e-mail having the same title is in plural, registering the e-mail address or the IP address of the sender of the e-mail having the same title, in the black list; and
an 11-4 step of hashing the contents of the text of the e-mail to convert the contents of the text into a code, and comparing the converted codes, then if e-mail having the same converted code is in plural, registering the e-mail address or the IP address of the sender of the e-mail having the same converted code, in the blacklist; and wherein
the 11-1 to 11-4 steps are carried out regardless of order.
